(19) United States
(12) Patent Application Publication
(10) Pub. No.: US 2013/0182526 A1
(43) Pub. Date: Jul. 18, 2013

(54) RECONFIGURABLE BUCKET OR CYLINDER MIXER AND METHOD OF ASSEMBLY

(71) Applicant: David Dertina, SR., Littleton, CO (US)

(72) Inventor: David Dertina, SR., Littleton, CO (US)

(21) Appl. No.: 13/350,082

(22) Filed: Jan. 13, 2012

(51) Int. Cl. B01F 13/00; B23P 11/00; B28C 5/44

(52) U.S. Cl. 366/56; 366/197; 366/198; 29/426.2

(57) ABSTRACT

A reconfigurable bucket mixer and method of assembly are disclosed. An example reconfigurable bucket mixer includes a bucket, a handle attached to the bucket, and a removable insert sized to fit inside the bucket to perform mixing functions. The bucket can also be reconfigured with the different inserts to mix grout, cement, concrete, soil, fertilizer, paint, mortar, plaster, drywall mud, chemicals, fabric or laundry, and even food, among other uses.

### BACKGROUND

There has long been a need to mix various components to produce desired compositions. Examples include, but are not limited to mixing cement with sand, gravel and water to produce concrete. While machine mixers are available for large scale or daily mixing jobs, many times only a small amount of mix is needed and a homeowner cannot justify the cost or renting or purchasing a machine mixer at their house.

Likewise, contractors often cannot justify a machine mixer for the many small jobs they may encounter. For example, air conditioning units, telephone, electrical and other equipment is typically installed on small concrete pads that do not justify the use of a machine mixer, or the cost of having a ready mix truck for delivery.

In other situations, power may not be available to operate a machine mixer. For example, concrete is often used when installing trails in remote parks, installation of highway signs, fence posts, or pot holes in the road. Moreover, power is still unavailable in many remote areas and most third world countries.

Instead, homeowners and contractors alike often rely on the standard wheelbarrow and shovel, using a manual labor mixing approach for small mixing jobs. While this may work on an occasional basis, a better and more thorough mixing of the ingredients would be more desirable. Other mixing devices are known, but have been specially configured for a single purpose.

### BRIEF DESCRIPTION OF THE DRAWINGS

FIG. 1 shows an example reconfigurable cylinder or bucket mixer.

FIG. 2 shows the example bucket mixer in an unassembled configuration.

FIGS. 3a-e are detailed top plan view showing an example handle for the bucket mixer.

FIG. 4 shows an example paddle assembly insert for mixing dry or wet contents in the bucket mixer.

FIG. 5 shows an example cage assembly insert for mixing paint in the bucket mixer.

FIGS. 6a-b show another example cage assembly insert for mixing paint in the bucket mixer.

### DETAILED DESCRIPTION

Homeowners, gardeners, landscapers, and contractors, among others, often have to rely on manual labor mixing approaches for small mixing jobs. In many cases, mixing by hand does not thoroughly mix the contents, and thus results in an inferior product that does not perform as well overtime. Some specialized mixing devices are known, but these devices are configured for a single purpose. While this may work for particular situations, a better approach is desirable.

A reconfigurable cylinder or bucket mixer is disclosed herein which addresses the shortcomings of prior approaches. In an example, the bucket mixer includes a bucket, and a removable handle attached to the bucket. The same bucket may be configured for different purposes using a variety of special inserts. For example, the bucket may be configured using the special inserts to mix grout, mortar, cement, concrete, soil, fertilizer, various chemicals, and paint, to name only a few examples of different uses. Indeed, the mixer may even be used to clean laundry or other fabrics by mixing with soap and water.

Before continuing, it is noted that as used herein, the terms “includes” and “including” mean, but is not limited to, “includes” or “including” and “includes at least” or “including at least.” The term “based on” means “based on” and “based at least in part on.”

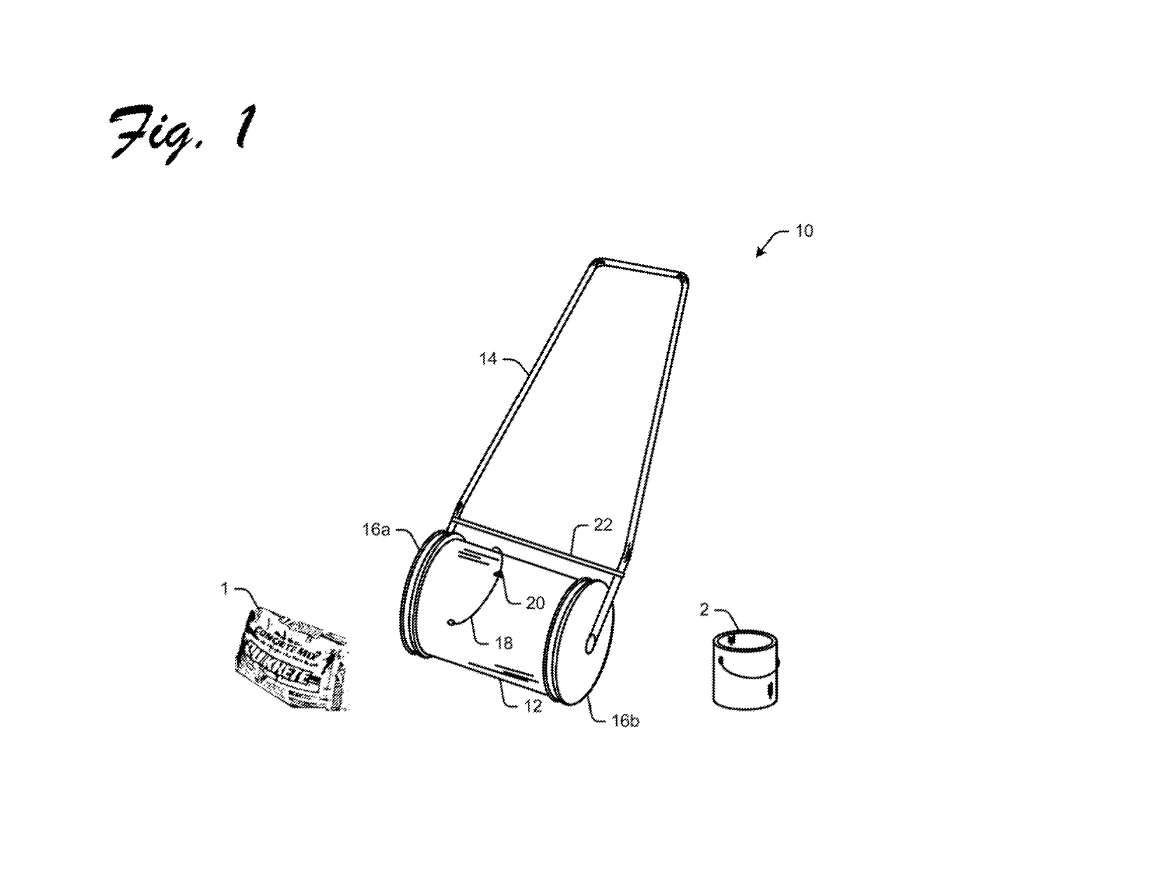

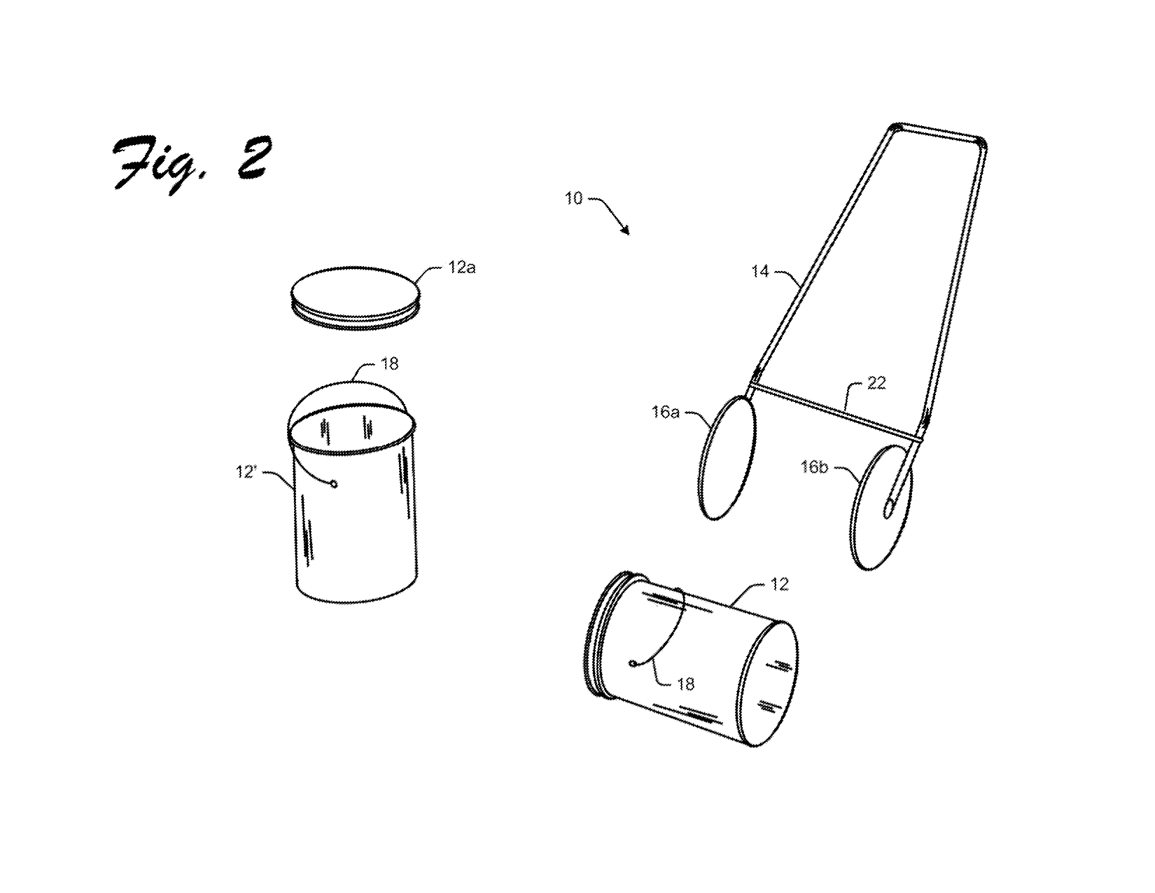

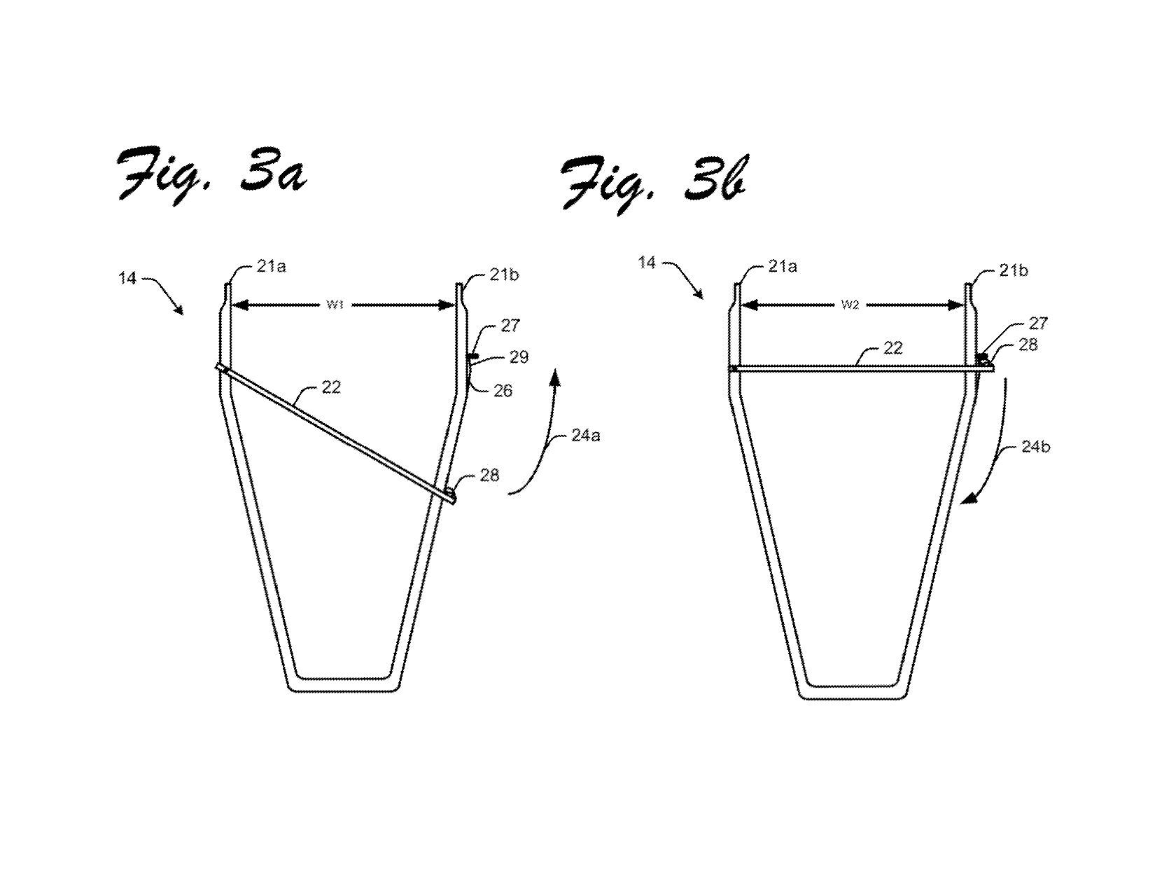

FIG. 1 shows an example reconfigurable bucket mixer 10. FIG. 2 shows the example bucket mixer 10 in an unassembled configuration. In the example, the bucket mixer 10 includes a bucket 12 with lid 12a, and a handle 14 attached to the bucket 10. The handle 14 may be configured as a push and/or pull handle, and may be adjustable for different size users and/or end-uses.

The bucket 10 can be readily configured and reconfigured by an end-user for any of a wide variety of different purposes. For example, the bucket mixer 10 may be configured to mix grout, mortar, cement, concrete, soil, fertilizer, and paint. As an illustration, a bag of ready-mix concrete 1, and a one gallon paint can 2 is shown in FIG. 1. Multiple containers such as paint cans may also be mixed at the same time within the bucket mixer 10.

The bucket mixer 10 includes wheels 16a-b. The wheels 16a-b may be wood, metal, plastic, rubber, or any other suitable material(s) to provide additional structure and rolling support. The wheels 16a-b may be readily replaced if broken or worn out, for example, by removing nuts used to fasten the wheels 16a-b to the handle 14.

During use, an end-user may add contents to be mixed into the bucket 12, attach the bucket 12 to the handle 14, and then push and/or pull the bucket mixer 10 using the handle 14 to mix the contents. The bucket 12 can then be removed from the handle 14 to access the mixed contents following the mixing operation.

The bucket mixer 10 may use a standard contractor bucket 12 (e.g., 5 gal., 6.5 gal., 7 gal., 8 gal. plastic bucket available at most home improvement stores). Of course, other buckets may also be used. Accordingly, the bucket 12 may be readily replaced, for example, with another standard contractor bucket 12′ illustrated in FIG. 2.

It is noted that one style bucket that may be used includes tapered sides, wherein the diameter of the opening or mouth of the bucket is larger (e.g., having a diameter equal to D1, not shown) and the bottom of the bucket is smaller (e.g., having a diameter equal to D2, not shown). But the lid of the bucket is a diameter D1 and can be fitted to the bottom of the bucket to make the bottom of the bucket also have a diameter D1. Such a bucket style is particularly desirable to enhance the mixing operations. That is, the tapered design of the bucket facilitates mixing of the contents, while fitting well in the handle 14 for rolling parallel to the ground (e.g., without being lopsided during the mixing operations). The bucket 12 may also include ribbing or other support structures.

The bucket 12 may include a handle 18. In an example, the bucket 12 may also include a handle attachment 20 to keep the handle 18 from getting in the way of mixing operations. The bucket mixer 10 can be readily configured and reconfigured by an end-user for any of a wide variety of different purposes.

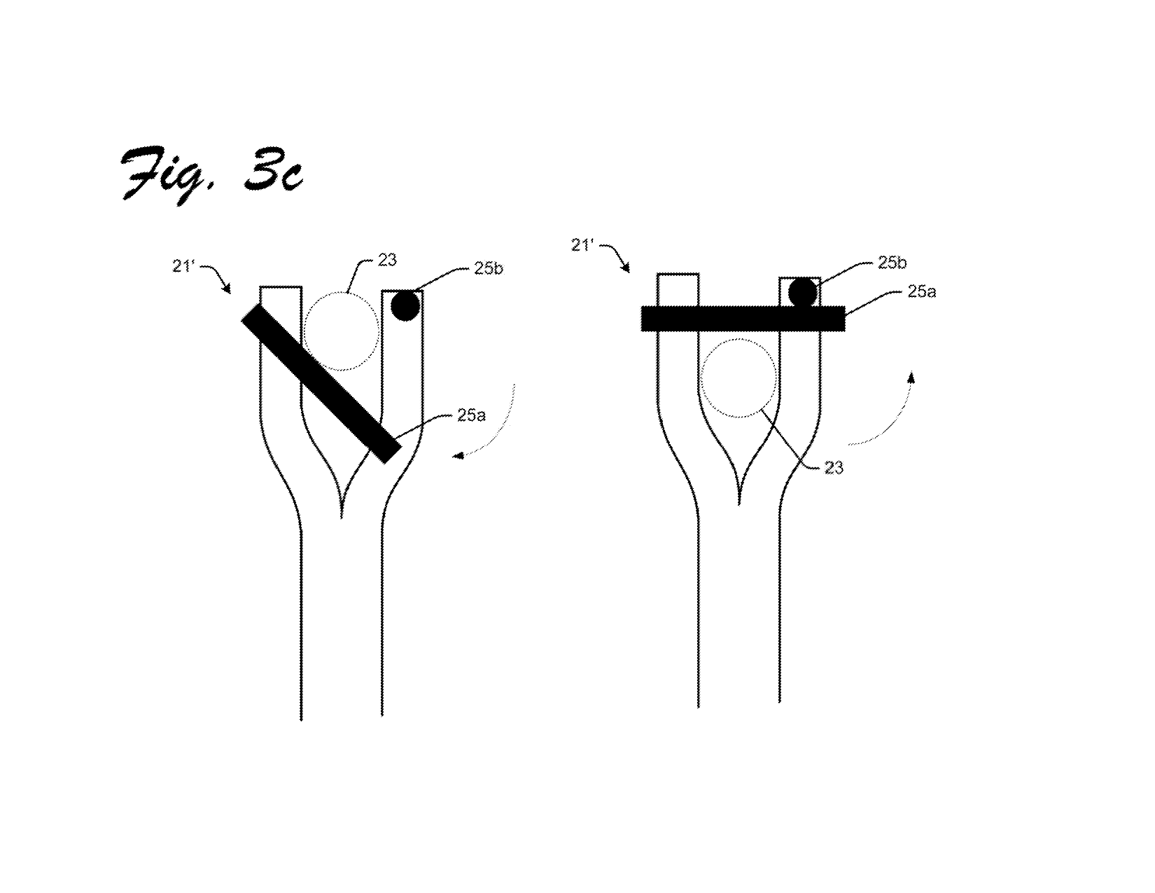

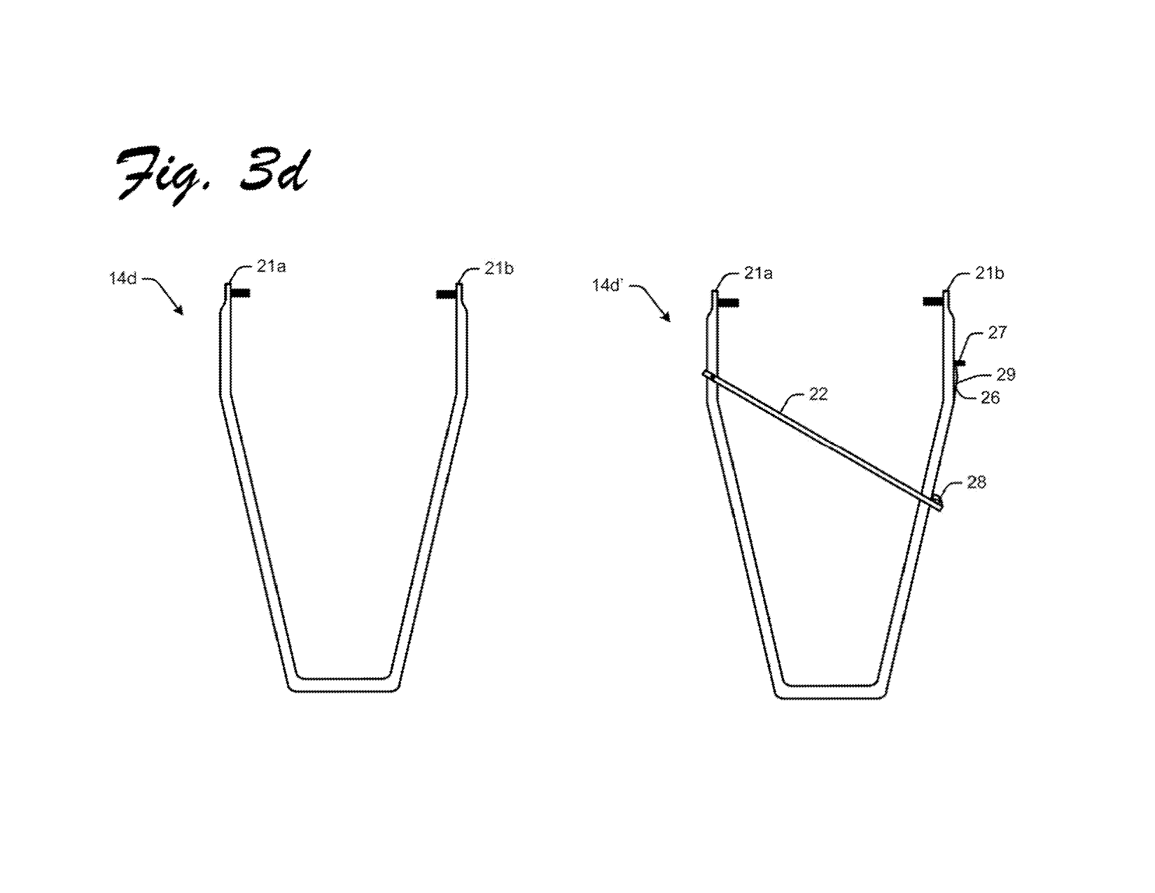

FIGS. 3a-e are detailed top plan view showing an example handle 14 for the bucket mixer 10. The example handle 14 includes a flexible frame having two legs 21a-b separated by an adjustable width. The adjustable width is illustrated by W1 in FIG. 3a and W2 in FIG. 3b. A swing arm 22 is rotatably attached to one of the two legs (e.g., leg 21a). The swing arm 22 is movable in a first direction illustrated by arrow 24a to reduce the adjustable width between the two legs 21a-b. For example, the width is reduced from W1 in FIG. 3a to W2 in FIG. 3b. Accordingly, the handle 14 can be used to lock or secure the bucket 12 between the two legs 21a-b.

The swing arm 22 is also moveable in a second direction illustrated by arrow 24b to unlock the bucket 12 from the two legs 21a-b by increasing the adjustable width. For example, the width is increased from W2 in FIG. 3b to W1 in FIG. 3b when the swing arm 22 is moved in the direction of arrow 24b. Accordingly, the handle 14 can be used to release the bucket from between the two legs 21a-b.

In an example, the swing arm 22 slides in a cam-like manner in the first and second directions. The cam-like operation can be seen in FIGS. 3a and 3b, wherein the swing arm 22 is moved along an angled portion 26 of the flexible frame. The angled portion 26 may also include an indent 27 such that a hook portion 28 moves into the indent 27 and against stopper 29 to secure the swing arm 22 in the locked position shown in FIG. 3b.

It is noted that other mechanisms may also be provided to lock and unlock the bucket 12 to the handle 14, and the bucket mixer 10 is not limited to the implementation described above with reference to FIGS. 3a-b.

For example, in FIG. 3c, a spring-loaded pin arm 25a on leg 21 is shown as it may be used to clasp around shaft 23 extending out from each end of the bucket 12 and engage stopper 25b after receiving the shaft 23. The pin arm 2. Still more designs for engaging the bucket 12 to the handle 14 are also contemplated.

FIG. 3d shows another embodiment of a handle 14d and 14d′ with shafts that can be fitted into the ends of the bucket 12. Also shown in FIG. 3d is the handle 14d without lever 22. FIG. 3e shows another embodiment of a handle 14e and 14e′ with holes formed in the handle that can receive pegs or shaft ends provided on the ends of the bucket 12. Also shown in FIG. 3e is the handle 14d without lever 22, such that the handle can be pulled apart and then “springs” back to the original width.

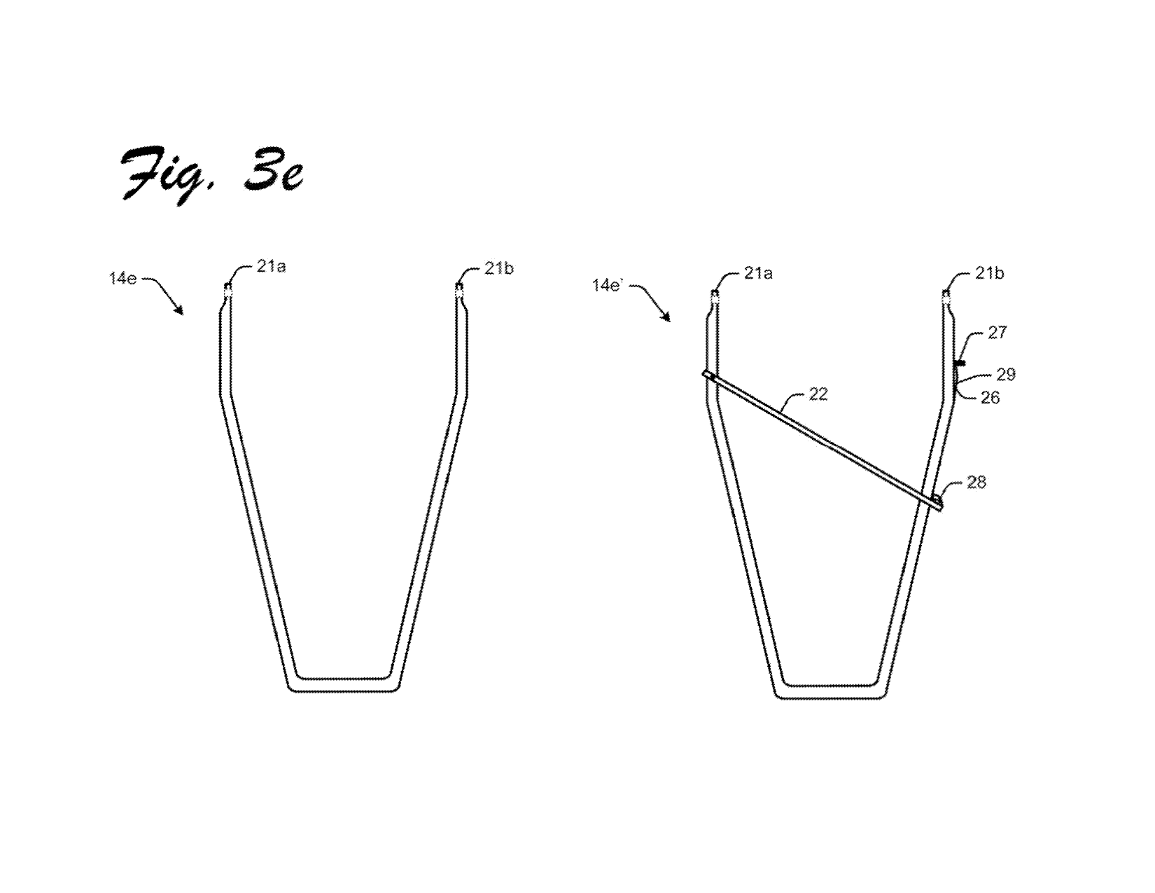

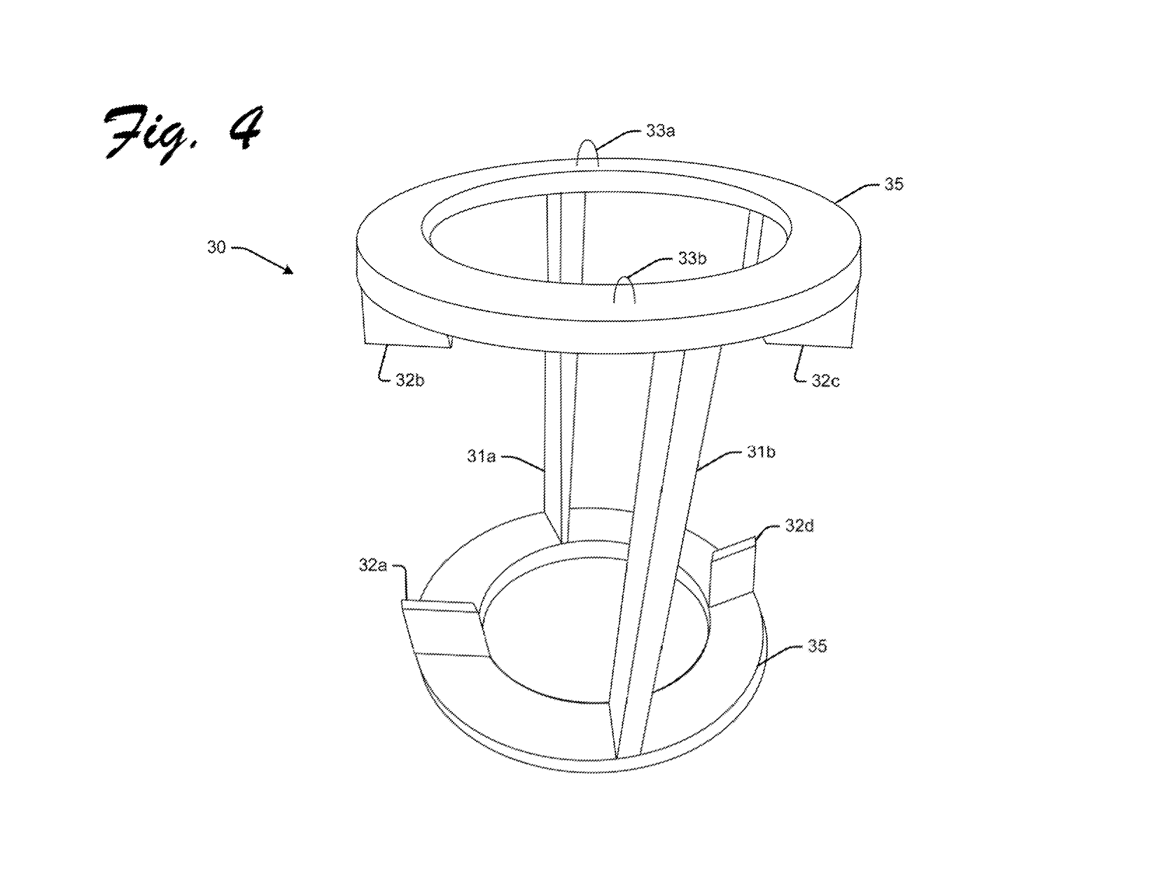

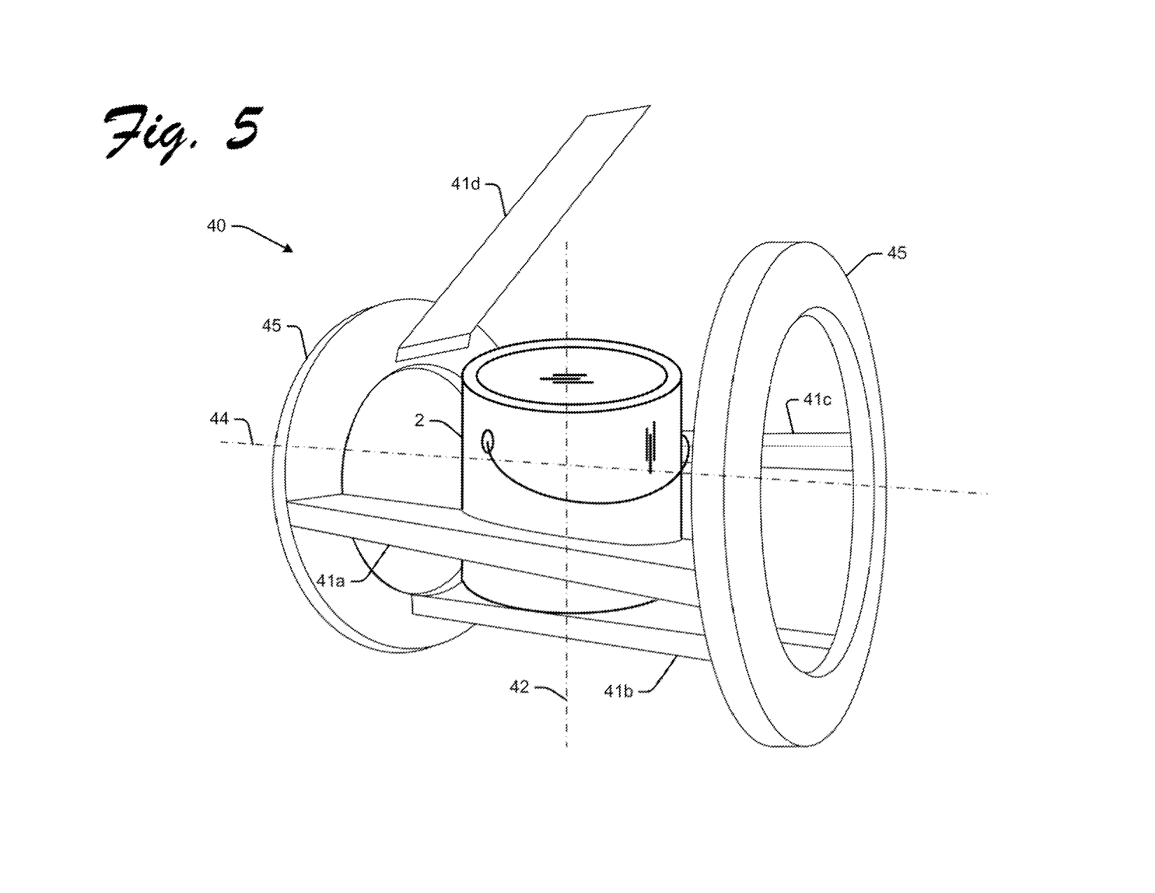

As mentioned above, the bucket mixer may be configured using a plurality of different inserts. Each of the different inserts may be sized to fit inside the bucket to perform multiple functions. Example inserts are described below with reference to FIGS. 4 and 5. Still other inserts which can be implemented with the bucket mixer, or various implementations thereof, will also become readily apparent to one having ordinary skill in the art after becoming familiar with the teachings herein.

FIG. 4 shows an example paddle assembly insert 30 for mixing loose, dry, or wet contents in the bucket mixer 10. The paddle assembly insert 30 is generally cylindrical in shape to fit inside the bucket (e.g., the bucket 12 shown in FIGS. 1 and 2). In an example, the paddle assembly insert 30 fits snug by way of interference fit so that the paddle assembly insert 30 does not spin around inside the bucket during a mixing operation. The insert may also include a friction-based material (e.g., rubber) to further enhance the interference fit between the insert and the walls of the bucket.

The paddle assembly insert 30 may include one or more paddles. For purposes of illustration, long paddles 31a-b are shown in FIG. 4, in addition to shorter paddles 32a-d. It is noted, however, that any size, shape, number and/or style of paddles may be provided for the paddle assembly insert 30. By way of illustration, and not intending to be limiting in any manner, a curved paddle may be used for mixing paint, a triangular tooth shaped paddle may be used for mixing soil, and a square blade paddle may be used for mixing concrete.

It is also noted that tabs 33a-b are shown in FIG. 4, which may be used to engage the lid (or bottom) of the bucket 12 to keep the insert from rotating as the bucket 12 rotates. Arched tabs 33a-b are shown in FIG. 4, which may engage an opening formed in the lid. But any suitable style tabs (and mating mechanism may be used.

FIG. 5 shows an example cage assembly insert for mixing paint in the bucket mixer. The cage assembly insert 40 is generally cylindrical in shape to fit inside the bucket (e.g., the bucket 12 shown in FIGS. 1 and 2). In an example, the cage assembly insert 40 fits snug by way of interference fit so that the cage assembly insert 40 does not spin around inside the bucket during a mixing operation. Again, the insert may also include a friction-based material (e.g., rubber) to further enhance the interference fit between the insert and the walls of the bucket.

The cage assembly insert 40 may include one or more supports for a paint container 2. For purposes of illustration, supports 41a-d are shown in FIG. 5. In this example, the support 41d is hingedly connected to the base portion 45 so that the paint container 2 can be inserted between supports 41a-c. The support 41d can then be lowered onto the top of the paint container 2. It is noted, however, that any size, shape, number and/or style of supports may be provided for the cage assembly insert 40. In another example, straps can also be provided to secure the paint container 2 within the cage assembly insert 40.

The supports maintain paint container 2 in a relatively fixed position during mixing operations to mix paint. In an example, the supports 41a-c maintain a central axis 42 of a standard paint container 2 (e.g., quart size, one-gallon, etc.) in a substantially perpendicular orientation relative to an axis 44 of rotation of the bucket to mix paint in the standard paint container while the bucket is being rolled around using the handle 14. Other orientations of the paint can (e.g., a 45 degree tilt) are also possible and are not limited to the perpendicular orientation described herein.

It is noted that the assembly 30 and 40 shown in FIGS. 4 and 5, respectively, also include at least one member to reinforce side walls of the bucket. By way of illustration, top and bottom members 35 and paddles 31a-b in FIG. 4 may serve to reinforce the side wall of the bucket 12. Also by way of illustration, the top and bottom members 45 and cage supports 41a-c in FIG. 5 may similarly serve to reinforce the side wall of the bucket 12.

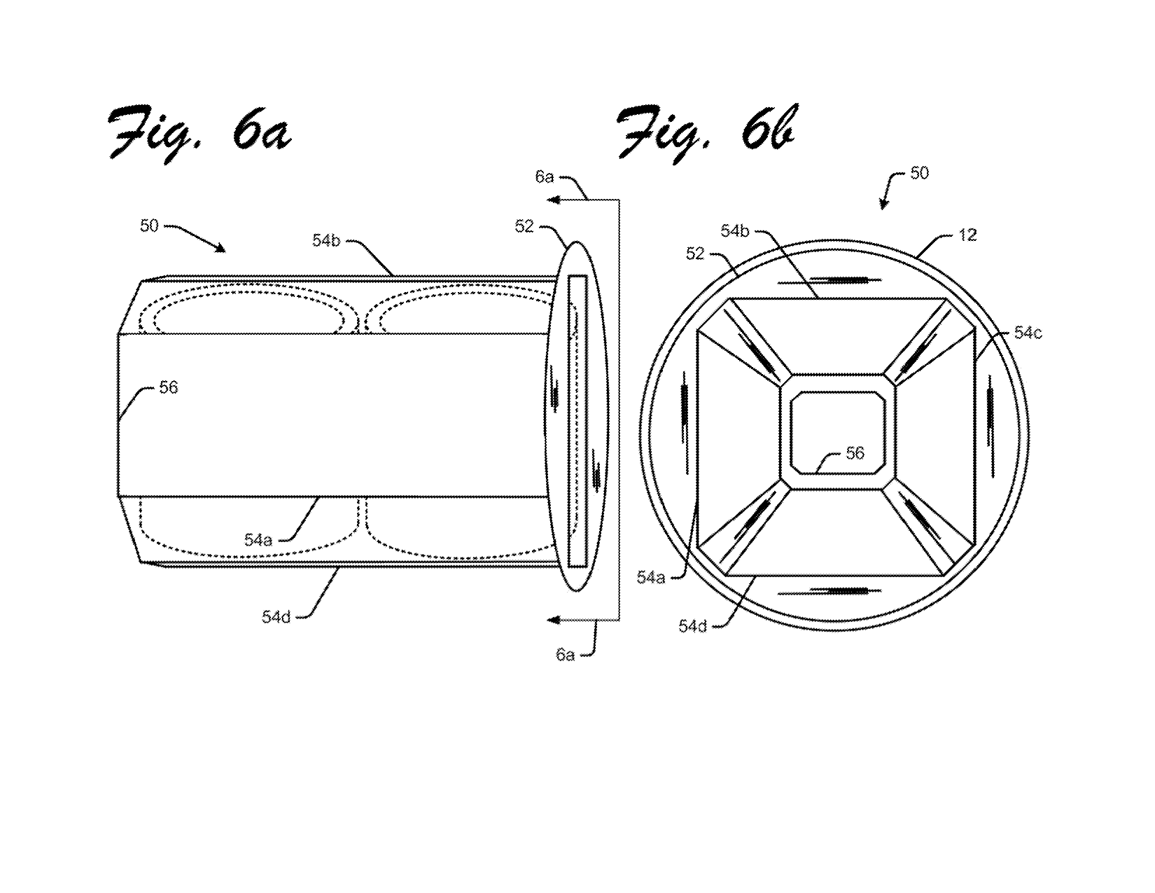

FIGS. 6a-b show another example cage assembly insert for mixing paint in the bucket mixer. The cage assembly insert 50 is generally rectangular-cylindrical in shape to fit inside the bucket (e.g., the bucket 12 shown in FIGS. 1 and 2). In an example, the cage assembly insert 50 fits snug by way of interference fit so that the cage assembly insert 50 does not spin around inside the bucket during a mixing operation. Again, the insert 50 may also include a friction-based material (e.g., rubber) to further enhance the interference fit between the insert and the walls of the bucket. Alternatively or in addition thereto, the insert may includes interlocking tabs 33 such as described above for FIG. 4.

FIG. 6a shows a side view of the insert 50, with paint cans shown in dashed lines for purposes of illustration. For example, 2 paint cans are shown, although the insert 50 may be sized for any type and number of containers. FIG. 6b is a top view of the insert 50, taken along lines 6a-6a in FIG. 6a.

The insert 50 is shown including a top circular portion 52 sized substantially the same size as the opening or mouth of the bucket 12 (see FIG. 6b). The insert 50 may also include a bottom portion 56. Side pieces 54a-d connect the bottom portion 56 to the top portion 52, forming a substantially rectangular insert area for receiving the paint cans.

Before continuing, it should be noted that the examples described above are provided for purposes of illustration, and are not intended to be limiting. Other apparatus and/or configurations may be utilized to implement the bucket mixer and carry out the operations described herein.

A method for assembling a multi-purpose bucket mixer is also disclosed, and may be implemented as shown in the drawings described above. An example assembly operation includes releasing a handle to receive a reconfigurable bucket. Another example assembly operation includes locking the handle to the reconfigurable bucket after receiving the reconfigurable bucket. Another example assembly operation includes fitting one of a plurality of different inserts into the reconfigurable bucket to perform at least one of multiple mixing functions.

The operations shown and described herein are provided to illustrate example implementations. It is noted that the operations are not limited to the ordering shown. Still other operations may also be implemented.

Still further operations may include reinforcing side walls of the reconfigurable bucket by an end-user with the different inserts. Operations may also include maintaining a standard paint container inside the reconfigurable bucket during a mixing operation so that a central axis of the standard paint container remains in a perpendicular orientation relative to an axis of rotation of the bucket.

It is noted that the examples shown and described are provided for purposes of illustration and are not intended to be limiting. Still other examples are also contemplated.

1. A reconfigurable cylinder or bucket mixer comprising:
a bucket;
a handle attached to the bucket; and
a removable insert sized to fit inside the bucket to perform mixing functions.

2. The bucket mixer of claim 1, wherein the bucket is configured to mix mortar, chemicals, grout, cement, concrete, soil, fertilizer, paint, and laundry using the removable insert.

3. The bucket mixer of claim 1, wherein the handle is removable from the bucket after unlocking.

4. The bucket mixer of claim 1, wherein the removable insert includes a paddle assembly with at least one mixing paddle.

5. The bucket mixer of claim 1, wherein the removable insert includes a cage assembly to maintain at least one container while mixing contents in the at least one container.

6. The bucket mixer of claim 1, wherein the removable insert includes at least one member to reinforce side walls of the bucket.

7. The bucket mixer of claim 1, further comprising an attachment for a bucket handle.

8. The bucket mixer of claim 1, further comprising wheels on opposite sides of the bucket.

9. The bucket mixer of claim 1, wherein the bucket is replaceable with a standard plastic contractor bucket without any configuration changes to the bucket mixer.

10. The bucket mixer of claim 1, wherein the handle further comprises:
a flexible frame having two legs separated by an adjustable width; and
a swing arm rotatably attached to one of the two legs, the swing arm movable in a first direction to reduce the adjustable width between the two legs and secure the bucket between the two legs of the handle, and the swing arm moveable in a second direction to increase the adjustable width between the two legs and release the bucket from between the two legs of the handle.

11. The bucket mixer of claim 10, wherein the swing arm slides in a cam-like manner in the first and second directions along an angled portion of the flexible frame.

12. The bucket mixer of claim 11, wherein the swing arm moves against a stopper when the bucket is secured between the two legs of the handle.

13. A multi-purpose cylinder or bucket mixer comprising:
a reconfigurable bucket;
a lockable handle releasably attached to the bucket; and
a plurality of different inserts each sized to fit separately inside the bucket to perform multiple functions.

14. The bucket mixer of claim 13, wherein one of the inserts includes a reinforced mixing paddle.

15. The bucket mixer of claim 13, wherein one of the inserts includes a cage assembly, the cage assembly reinforcing side walls of the bucket, and the cage assembly maintaining a central axis of a standard paint container in a perpendicular orientation relative to an axis of rotation of the bucket to mix paint in the standard paint container.

16. The bucket mixer of claim 1, further comprising wheels formed as part of the bucket, the wheel provided on opposite sides of the bucket.

17. The bucket mixer of claim 1, wherein the handle further comprises:
a flexible frame having two legs separated by an adjustable width;
a swing arm rotatably attached to one of the two legs, the swing arm movable in a first direction to reduce the adjustable width between the two legs and secure the bucket between the two legs of the handle, and the swing arm moveable in a second direction to increase the adjustable width between the two legs and release the bucket from between the two legs of the handle;
wherein the swing arm slides in a cam-like manner in the first and second directions along an angled portion of the flexible frame; and
wherein the swing arm moves against a stopper when the bucket is secured between the two legs of the handle.

18. A method for assembling a multi-purpose cylinder or bucket mixer, the method comprising:
releasing a handle to receive a reconfigurable bucket;
locking the handle to the reconfigurable bucket after receiving the reconfigurable bucket; and
fitting one of a plurality of different inserts into the reconfigurable bucket to perform at least one of multiple mixing functions.

19. The method of claim 18, further comprising reinforcing side walls of the reconfigurable bucket by an end-user with the different inserts.

20. The method of claim 18, further comprising maintaining at least one standard paint container inside the reconfigurable bucket during a mixing operation so that a central axis of the standard paint container remains in a perpendicular orientation relative to an axis of rotation of the bucket.
